(19) United States
(12) Patent Application Publication
(10) Pub. No.: US 2026/0348349 A1
(43) Pub. Date: Nov. 5, 2026

(54) UNDERWATER HYDRO TURBINE WITH RADIAL WATERJET NOZZLES

(71) Applicant: Drago SENIC, Glasgow (GB)

(72) Inventor: Drago SENIC, Glasgow (GB)

(21) Appl. No.: 19/123,786

(22) PCT Filed: Oct. 24, 2022
(86) PCT No.: PCT/IB2022/060196

§ 371 Date: Apr. 24, 2025

(51) Int. Cl. F03B 3/08; F03B 13/10

(52) U.S. Cl. CPC F03B 3/08; F03B 13/10; F05B 2220/706; F05B 2240/14; F05B 2240/97

(57) ABSTRACT

A turbine comprising a turbine rotor comprising an axial fluid inlet, at least one tangential fluid outlet, and a fluid flow passage connecting the axial fluid inlet with each of the at least one tangential fluid outlets. A turbine stator, rotatably connected to the turbine rotor, and housing an electrical generator having a generator rotor in mechanical communication with the turbine rotor. And a support structure for securing and supporting, in use, the turbine stator in the path of flowing fluid such that the axis of the turbine rotor is parallel to the direction of fluid flow and at least the axial fluid inlet is submerged in the flowing fluid.

A turbine comprising a first and second casing sections:
the first casing section defining a turbine rotor comprising an axial fluid inlet, at least one tangential fluid outlet on an outer surface of the first turbine casing section, and a fluid flow passage connecting the axial fluid inlet with each of the at least one tangential fluid outlets; (support found in paragraph 19)
the second casing section defining a turbine stator, rotatably connected to the turbine rotor, and housing an electrical generator having a generator rotor in mechanical communication with the turbine rotor; and
a support structure for securing and supporting; in use, the turbine stator in the path of flowing fluid such that the axis of the turbine rotor is parallel to the direction of fluid flow and at least the axial fluid inlet is submerged in the flowing fluid.

### FIELD OF THE INVENTION

The invention relates to a turbine for submersion in flowing water, driven by the flow of the surrounding water to generate electricity.

### BACKGROUND OF THE INVENTION

The need to generate electricity without burning fossil fuels is well documented and almost universally understood. One of the many renewable sources of energy currently exploited is the kinetic energy in flowing water.

U.S. Pat. No. 7,722,313 and WO2011/107816 disclose a turbine driven by a working fluid which is received by an axial inlet and expelled circumferentially through nozzles at the free ends of blades extending from a central hub. The turbine inlet is fed by an inlet pipe and the assembly is housed in a housing. The assembly is not configured for complete submersion in the working fluid, since the inlet is fed by an inlet pipe and the turbine forms part of a circuit of working fluid. The inlet is sealed from the external environment to prevent the escape of working fluid from the inlet pipe, and it is thus incapable of receiving fluid from its surroundings.

WO2014/022887 discloses a similar apparatus with an inlet pipe structure. The inlet pipe is an essential part of the support structure for the turbine. The turbine is supported by two plates. Thus, the turbine is particularly unsuitable for submersion in an external working fluid.

WO2018/112530 discloses a very similar system to WO2014/022887. The turbine in this case is designed for 6000 revolutions per minute and is therefore enclosed in a housing in order to prevent injury in the event of a bearing failure. The system is entirely unsuitable for use submerged in water.

GB2425329 discloses an apparatus which drives a turbine for the generation of electricity by extracting kinetic energy from water. It includes a horizontal axis-type turbine which is driven by horizontally flowing water, such as a tidal body of water or a river. This horizontal axis-type turbine is driven by impeller blades extending radially from the axis of rotation. Impeller blades of this kind are often vulnerable to snapping, since they are necessarily long, narrow and thin. Their rotation through an area of open water, in use, also poses a threat to creatures living in the water who may try to pass through the area of rotation.

A Segner wheel is a water-driven turbine with a vertical axis of rotation. Segner wheels are not submerged in water. Water enters a Segner vertically through its axis, typically driven by gravity. This water leaves the Segner wheel horizontally, through radial outlets which direct escaping water tangentially to the circumference of the Segner wheel, in order to generate torque.

It is an object of the present invention to provide a turbine capable of being submerged in flowing water, harvesting the kinetic energy of the flowing water and converting it into electrical power.

### SUMMARY OF THE INVENTION

According to a first aspect of the invention there is provided a turbine comprising a turbine rotor comprising an axial fluid inlet, at least one tangential fluid outlet, and a fluid flow passage connecting the axial fluid inlet with each of the at least one tangential fluid outlets. A turbine stator, rotatably connected to the turbine rotor, and housing an electrical generator having a generator rotor in mechanical communication with the turbine rotor. And a support structure for securing and supporting, in use, the turbine stator in the path of flowing fluid such that the axis of the turbine rotor is parallel to the direction of fluid flow and at least the axial fluid inlet is submerged in the flowing fluid.

An embodiment of the first aspect, wherein the support structure is configured to secure and support, in use, the turbine stator such that the axis of the turbine rotor is substantially parallel with the direction of fluid flow. The support structure may be a pillar configured to extend substantially perpendicular, in use, from a supporting surface.

An embodiment of the first aspect, wherein the turbine stator is sealed against the ingress of fluid.

An embodiment of the first aspect, wherein the fluid flow passage comprises an inlet chamber and at least one outlet chamber, in fluid communication with one another. The fluid flow passage may be shaped so as to redirect axially flowing fluid entering the inlet chamber so that it exits each of the at least one tangential fluid outlets flowing tangentially to the turbine rotor. It may also comprise at least two tangential fluid outlets with at least two respective outlet chambers, wherein the outlet chambers are separated by partition walls.

An embodiment of the first aspect, wherein the axial cross-sectional area of the axial fluid inlet is greater than the sum of the tangential cross-sectional areas of the at least one tangential fluid outlets.

### BRIEF DESCRIPTION OF THE DRAWINGS

The invention will be described in more detail, by way of example, with reference to the following drawings:

FIG. 1 depicts an external view of an embodiment of the invention;

FIG. 2 depicts a side hidden line view of an embodiment of the invention;

FIG. 3 depicts a front and side cross-section of the front wheel of an embodiment of the invention;

FIG. 4 depicts a front, side and angled external view of the front wheel section of an embodiment of the invention;

FIG. 5 shows torque vs rotational speed of the front wheel of an embodiment of the invention.

### DETAILED DESCRIPTION

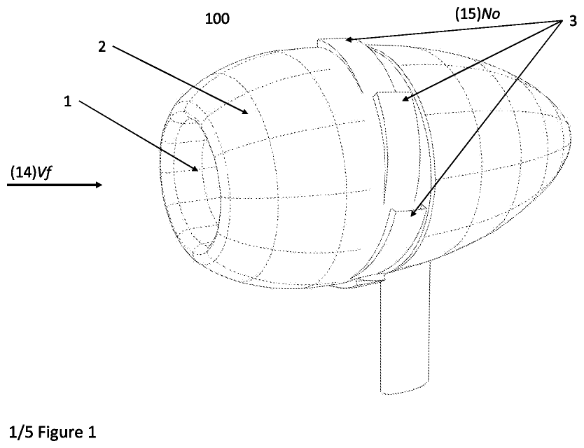

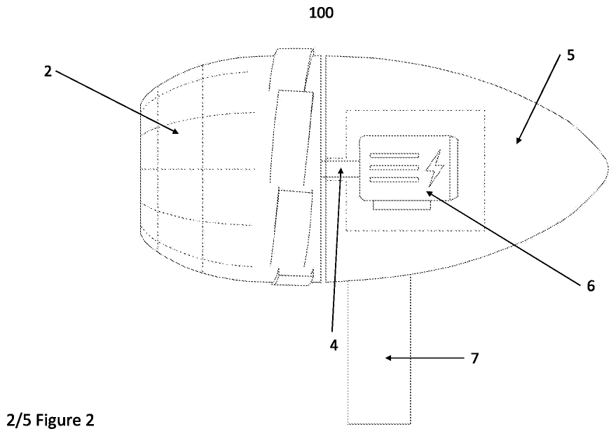

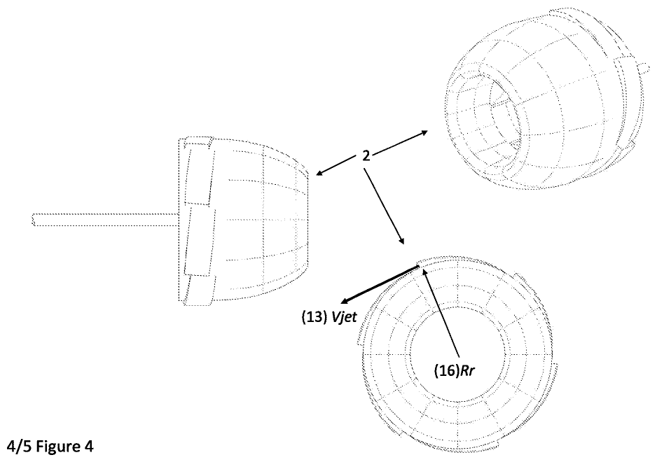

With reference to FIGS. 1 to 5, a preferred embodiment of the current invention, more specifically an underwater turbine 100 for generating electrical power from water flow, will now be described.

The turbine 100 is designed for operation under the surface of moving water, without the need for construction of water dams etc. Preferably having a roughly teardrop shape (although other shapes can be used). The teardrop shape turbine is preferable as it allows installation of more turbines in chain behind each other, where two adjacent turbines can be closer to each other. On the other hand, with a “square shaped” turbine for example, the distance between two nearby turbines would need to be several times larger. Teardrop shaped turbines also have the ability to naturally position themselves in parallel to the flow of the fluid and front itself directly against the fluid speed vector, with no need for implementing turbine “stabilizers”.

The bulbus end of the turbine 100 points ‘upstream’. The turbine comprises a rotating front wheel 2, which forms the majority of the bulbus portion of the teardrop shape; this is attached to axle 4, which runs along a central axis, which in turn runs longitudinally through the centre of the turbine 100. Axle 4 extends out the back of front wheel 2 and into a static waterproof case 5, which forms the pointed portion of the teardrop shape. At the end of axle 4 distal to front wheel 2 the axle 4 is connected to an electric generator 6, which sits inside static waterproof case 5. Axle 4 transmits the mechanical energy from front wheel 2 when it is rotating to the electrical generator 6 in order to generate electricity. Static waterproof case 5 is mounted onto stand 7, which is anchored to a suitable point and holds the case 5 and front wheel 2 (except for rotation) still. Any additional desired wiring to connect the generator 6 to a wider grid can be passed through sand 7 also.

Turbine 100 is a reaction-type turbine and incorporates features of axial and radial turbines. It is of the horizontal axis turbine style traditionally used for wind turbines, but the present invention utilises water fluid flow rather than air fluid flow. However the present invention would be functional with fluid airflow also.

The turbine works as the moving flowing water flows axially into the water inlet 1 in a direction substantially parallel to the longitudinal axis of the turbine 100 (best indicated by the arrow of 14). Water inlet 1 is positioned at the ‘front’ of the turbine 100 and therefore at a ‘front’ of the front wheel 2. At the back of the front wheel two 2 positioned around the outer circumference are a plurality of nozzles 3, pointed tangentially in the same direction as each other in relation to the circumference of front wheel 2. The water inlet 1 and plurality of nozzles 3 are in fluid communication with each other, such that, due to the hydrostatic pressure the water is ejected from the plurality of nozzles 3. Due to the direction of the plurality of nozzles 3 the water jets produce a useful torque which causes the front wheel/rotor 2 to rotate. Namely, the useful torque is produced by propulsive force of thrust induced by the water jets exiting from the nozzles.

It is assumed that the flow speed 14 of the water outside the turbine 100 is Vf (speed of the river the turbine 100 is placed in, etc). Also, the number of nozzles placed around the front wheel/rotor 2 is indicated by No.

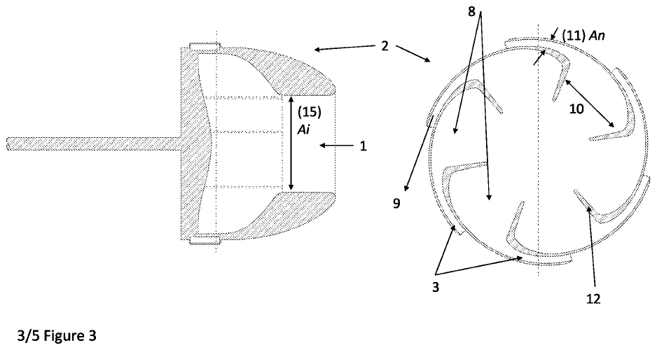

With specific reference to FIG. 3, the front wheel/rotor 2 comprises the water inlet 1 in fluid communication with a plurality of nozzles 3 which are placed around the circumference of the rotating front wheel/rotor 2. The fluid pathway between inlet one and the plurality of nozzles 3 comprises a plurality of partition chambers 8 separated by partition walls 12.

Hydrostatic pressure is maximised within the partition chambers 8 due to the water having its lowest speed within the chambers 8. The cross-sectional area 10 of the partition chambers 8 is significantly larger than the cross-sectional area 11/Aₙ of the nozzles 3. Therefore, the speed of the water V_{c} inside the chambers 8 is much lower than the speed inside the nozzles 3.

For this to work, the cross-sectional area of the water inlet 1, noted as Aᵢ, is much larger than the sum of all the cross-sectional areas Aₙ of the plurality of nozzles 3.

When the front wheel 2 is not rotating, the pressure difference (noted as ΔP) between the pressure inside the partition chambers 8 (noted as Pᵢₙ), and the pressure outside the turbine 100 (noted as Pₒᵤₜ) can be described as:

$$Δ P = {P}_{in} - {P}_{out} = \frac{ρ \times {Vf}^{2}}{2}$$

[symbol] being the density of water (1000 Kg/m³).

When the front wheel/rotor 2 is not spinning, the speed of the water exiting the nozzles (noted as Vⱼₑₜ) can be estimated to be substantially the same as the speed of the water moving outside (Vf).

The total torque produced by the propulsive force of thrust induced by the water jets 9 exiting from the nozzles 3 can be described as:

$$T 0 = {N}_{O} \times {R}_{r} \times {A}_{n} \times ρ \times {Vf}^{2}$$

Rᵣ being the radius distance from the centre of the turbine to the nozzle exit.

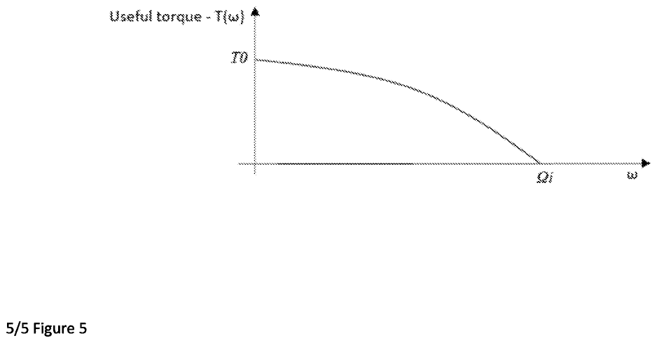

With specific reference to FIG. 5, when the front wheel/rotor 2 starts to rotate (therefore starting to produce mechanical energy at axle 4, which in turn starts turning generator 6 and producing electricity), the useful torque (T) starts to decrease from its initial value T0 (torque when rotor 2 is stationary in flowing water). The rotational speed (noted as ω) of the rotor 2 begins to speed up until the rotor 2 reaches the idle speed Ωᵢ, the useful torque T reaches 0 and the rotor 2 is spinning at maximum speed. The idle speed Ωᵢ is the maximum rotational speed of the rotor 2 and is the rotating speed of the rotor 2 when the flux of water flow exiting the plurality of nozzles 3 has become equal to the flux of water flow entering the inlet 1.

The invention has been described with reference to a preferred embodiment. The description is intended to enable a skilled person to make the invention, not to limit the scope of the invention. The scope of the invention is determined by the claims.

1. A turbine (100) comprising first (2) and second (5) casing sections, characterised in that:
the first casing section (2) made of a turbine rotor having an axial fluid inlet (1), at least one tangential fluid outlet (3) located on an outer surface of the first casing section (2), and a fluid flow passage connecting the axial fluid inlet (1) with each of the at least one tangential fluid outlets (3);
the second casing section (5) being a turbine stator, rotatably connected to the first casing section (2), and housing an electrical generator (6) having a generator rotor in mechanical communication with the first casing/turbine rotor (2); and
a support structure (7) for when in use, securing and supporting the turbine stator (5) in the path of flowing fluid such that the axis of the turbine rotor (2) is parallel to the direction of fluid flow and at least the axial fluid inlet (1) is submerged in the flowing fluid.

2. A turbine (100) according to claim 1, wherein the support structure (7) is configured to secure and support, in use, the turbine stator (5) such that the axis of the turbine rotor (2) is substantially parallel with the direction of fluid flow.

3. A turbine (100) according to claim 2, wherein the support structure (7) is a pillar configured to extend substantially perpendicular, in use, from a supporting surface.

4. A turbine (100) according to any preceding claim, wherein the turbine stator (5) is sealed against the ingress of fluid.

5. A turbine (100) according to any preceding claim, wherein the fluid flow passage comprises an inlet chamber and at least one outlet chamber (8), in fluid communication with one another.

6. A turbine (100) according to claim 5, wherein the fluid flow passage is shaped so as to redirect axially flowing fluid entering the inlet chamber so that it exits each of the at least one tangential fluid outlets (3) flowing tangentially to the turbine rotor (2).

7. A turbine (100) according to claim 5 or claim 6, comprising at least two tangential fluid outlets (3) with at least two respective outlet chambers (8), wherein the outlet chambers are separated by partition walls (12).

8. A turbine (100) according to any preceding claim, wherein the axial cross-sectional area of the axial fluid inlet (1) is greater than the sum of the tangential cross-sectional areas of the at least one tangential fluid outlets (3).
